(19) United States
(12) Patent Application Publication
(10) Pub. No.: US 2018/0148111 A1
(43) Pub. Date: May 31, 2018

(54) MASTER TRACK LINK TOOTH PROFILE MACHINING

(71) Applicant: Caterpillar Inc., Peoria, IL (US)

(72) Inventors: Stan Robert Parrott, Chillicothe, IL (US); Rohit Arun Bhapkar, Dunlap, IL (US); Shihua Wan, TIANJIN (CN); Yaodong Zhou, TIANJIN (CN); BINGFENG ZHANG, TIANJIN (CN); Fuqi Liu, Tianjin (CN)

(73) Assignee: Caterpillar Inc., Peoria, IL (US)

(21) Appl. No.: 15/363,100

(22) Filed: Nov. 29, 2016

(51) Int. Cl. B62D 55/21; B23C 1/14; B23C 5/08

(52) U.S. Cl. CPC B62D 55/213; B23C 1/14; B23C 2220/36; B23C 2220/605; B23C 5/08

(57) ABSTRACT

A method for manufacturing a master track link comprises machining a rough tooth profile using a milling process, and machining a finished tooth profile using a milling process.

### TECHNICAL FIELD

The present disclosure relates to a method and apparatus for machining a master track link used for completing a track chain of an endless undercarriage drive employed by earth moving, construction and mining equipment and the like. Specifically, the present disclosure relates to a method and apparatus that reduces the need for grinding intricate geometry such as the tooth profile for such master links.

### BACKGROUND

Earth moving, construction and mining equipment and the like work are often used in rough, off-road terrain. These machines often employ an endless drive with track shoes that is better able to propel the machines in such environments over obstacles and uneven terrain, etc. The track chains, which include shoes, are held together by a series of interconnected track links, pins and bushings that are supported on the drive sprocket, idler and support rollers of the machine. As can be imagined, a device is typically provided that allows the track chain to be routed about the drive sprocket, idler and support rollers before the free ends of the chain are joined together. This device is called a “master link”.

Two master track links are often used that have similar geometry that mate with each other before the links are fastened together. The mating geometry often includes teeth with a series of undulations that fit with the complimentarily shaped geometry of the other master link. This geometry is designed so that, once the master links are fastened together, the joined master links may withstand the forces, especially the tensile force, which is exerted on the chain when used. If this joint between the master links fails, then the chain may fall off the undercarriage, which is undesirable. In practice, the master links may be joined and then the final shoe may be fastened to the master links. The fasteners used to attach the final shoe may extend through the shoe and engage threaded holes of the two master links, helping to hold the master track link joint together.

As can be imagined, it is desirable for the teeth or other undulations to be accurately and precisely formed so that when the master links mate with each other, there is no slop or mismatch between the teeth of the master links. If such slop or mismatch exists, the master link joint may fail in the field, leading to unwanted downtime for the machine.

To that end, teeth, undulations or other critical geometry of the master link may be precision ground or cut using wire EDM after being broached to achieve the desired accuracy and precision of the geometry. However, this may require capital intensive equipment and an increased machining time, leading to high costs associated with making master track links.

Accordingly, a need exists for a method and apparatus that can provide accurate and precise geometry, especially for the interlocking geometry, of master track links that is less expensive and/or faster than has yet been devised.

One prior master track link manufacturing technique is contained in U.S. Pat. No. 8,420,972 to Cho. The '972 patent suggests using a series of ball cutters or end mills to create the desired geometry (see for example FIG. 7 of the '972 patent). However, this still requires the use of multiple cutters and may still not be able to form the tooth profile with enough accuracy and precision. Also, the '972 patent requires multiple jigs and set-ups to create the desired master link geometry (see FIGS. 4 and 5 versus FIGS. 6 and 7 for example). More importantly, the tooth profile of the master link in the '972 patent is cut using an expensive and time consuming wire EDM process (see FIGS. 4 and 5).

Therefore, a simpler and more efficient process and apparatus for making master links is still warranted.

### SUMMARY

A master track link is provided comprising a body defining a top surface, a bottom surface, a first side surface and a second side surface defining a thickness therebetween, a proximate end and a distal end, wherein the body further defines a tooth profile including a plurality of surfaces, the tooth profile extending from the top or bottom surface, the body defines a bore adjacent the distal end or adjacent to the proximate end, and all the surfaces of the tooth profile exhibit finishing milling marks.

An apparatus for machining a master track link is provided comprising a CNC machine including at least four axis maneuverability, a frame, a table attached to the frame, and a rotating spindle attached to the frame, a fixture attached to the table including a stepped platform configured to support a master track link, a master track link positioned on the platform of the fixture, and a plurality of clamp arrangements configured to hold the master track link to the fixture.

A method for manufacturing a master track link is provided comprising machining a rough tooth profile using a milling process, and machining a finished tooth profile using a milling process.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 illustrates a four axis horizontal milling center according to an embodiment of the present disclosure that may be used to machine a master track link according to an embodiment of the present disclosure.

FIG. 2 is a perspective view of a newly forged bushing master link clamped using a jig to the table of a milling center such as that disclosed in FIG. 1.

FIG. 3 is a perspective view of a pin master link clamped using another jig to the table of a milling center such as that disclosed in FIG. 1.

FIG. 4 is a perspective view of an embodiment of a side milling cutter with inserts that may be used to machine the troughs and side surfaces of a rough tooth profile of the master track link of FIG. 3.

FIG. 5 is a front perspective view of a master track link having a rough tooth profile machined using the cutter of FIG. 4.

FIG. 6 is an enlarged detail view of the tooth profile of the master track link of FIG. 5.

FIG. 7 is a front perspective view of another embodiment of a side milling cutter used to form the troughs and the side surfaces of a rough tooth profile of a master track link.

FIG. 8 is a front perspective view of a face mill cutter used to machine the top surfaces of the tooth profile and top and bottom angled surfaces, typically formed before using the side milling cutter of FIG. 7.

FIG. 9 is front perspective view of a master track link with a rough tooth profile machined using the side milling cutter and face mill cutter of FIGS. 7 and 8.

FIG. 10 is an enlarged view of the tooth profile of the master track link of FIG. 9.

FIG. 11 is a front perspective view of another side milling cutter that may be used to create the troughs and side surfaces of a rough tooth profile of a master track link.

FIG. 12 is a front perspective view of a master track link with a tooth profile that was formed using the side milling cutter of FIG. 11.

FIG. 13 is an enlarged detail view of the tooth profile of FIG. 12.

FIG. 14 is a perspective view of a side milling cutter used to create the troughs, side surfaces and blend surfaces that transition to the top surfaces of the tooth profile.

FIG. 15 is a perspective view of a face mill that may be used to from the top surface, the top angled surface and the bottom angled surface of the finished tooth profile of FIG. 14.

FIG. 16 is a front perspective view of a master track link that has a tooth profile that is finish machined using the side milling cutter of FIG. 14 and the face mill of FIG. 15.

FIG. 17 is an enlarged detail view of the tooth profile of the master track link of FIG. 16.

FIG. 18 is a graph showing the dimensions of the tooth profile of a master track link such as shown in FIG. 17 for five different master track links machined using a rough tooth profile machining and a finish tooth profile machining apparatus and method according to any of the embodiments discussed herein relative to FIGS. 1 thru 15.

FIG. 19 is an enlarged detail view of the graph of FIG. 18, focusing on the middle two teeth of that profile.

FIG. 20 is a further enlarged detail view of the graph of FIG. 19 focusing on a single tooth and trough profile.

FIG. 21 is an enlarged detail view of the graph associated with the first tooth, the first trough the upper angled surface of the tooth profile of FIG. 19.

FIG. 22 is an enlarged detail view of the beginning section of the tooth profile and its obtuse included angle formed between a vertically oriented surface and the top angled surface.

FIG. 23 is a front view of a bushing master track link mated with a pin master track link, wherein both master track links were manufactured using a previous process that involved broaching and then grinding the teeth.

FIG. 24 is an enlarged detail view of the undulations of the master track links of FIG. 23.

FIG. 25 is front view of a bushing master track link with teeth finished machined according to an embodiment of the present disclosure mated with ground teeth of a pin master track link having ground teeth.

FIG. 26 is an enlarged detail view of the mating of the teeth of the master track links of FIG. 25.

FIG. 27 is a schematic representation of a method for manufacturing a master track link according to an embodiment of the present disclosure.

FIG. 28 is a perspective view of a CMM machine taking measurements of a master track link that may be used with various embodiments of the method for manufacture or inspection of the present disclosure.

FIG. 29 is a flowchart depicting the steps of a method for manufacturing a master track link according to an embodiment of the present disclosure.

FIG. 30 is a plot of a portion of a tooth profile showing the nominal profile, the measured profile, the profile after an offset adjustment has been made, the upper tolerance boundary, the lower tolerance boundary, and deviations.

FIG. 31 is a flow chart of a method for adjusting the machining of a master track link that may be used in conjunction with the method contained in FIG. 29.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of an apparatus and a method for machining a master track link will now be described. In one particular embodiment, a four axis horizontal milling center may be used to creatively fixture a master track link onto its table and then standard insert tools may be used to cut a first rough tooth profile onto the master link. Then, one may use a custom built insert tool to finish machine the tooth profile to print tolerance. In some embodiments, in order to achieve the desired requirements, a custom programmed CMM yields measurement data that is imported into a custom formula EXCEL file to tell an operator how to make adjustments to the machining. Alternatively, a customized application may be created to be used instead of an EXCEL file. In yet further embodiments, this adjustment may be performed automatically by a program developed to receive the measurement data and create desired offsets in the programming of the milling center, etc.

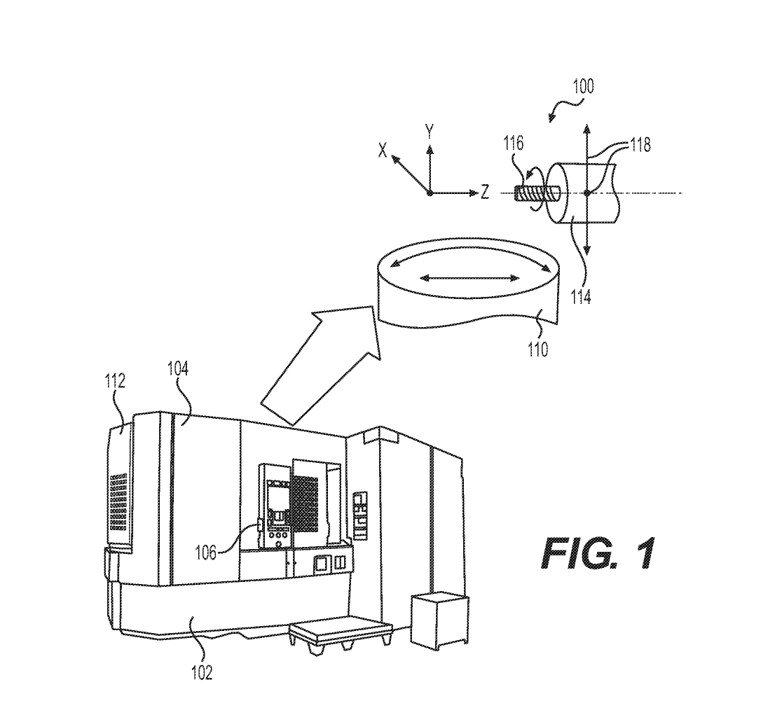

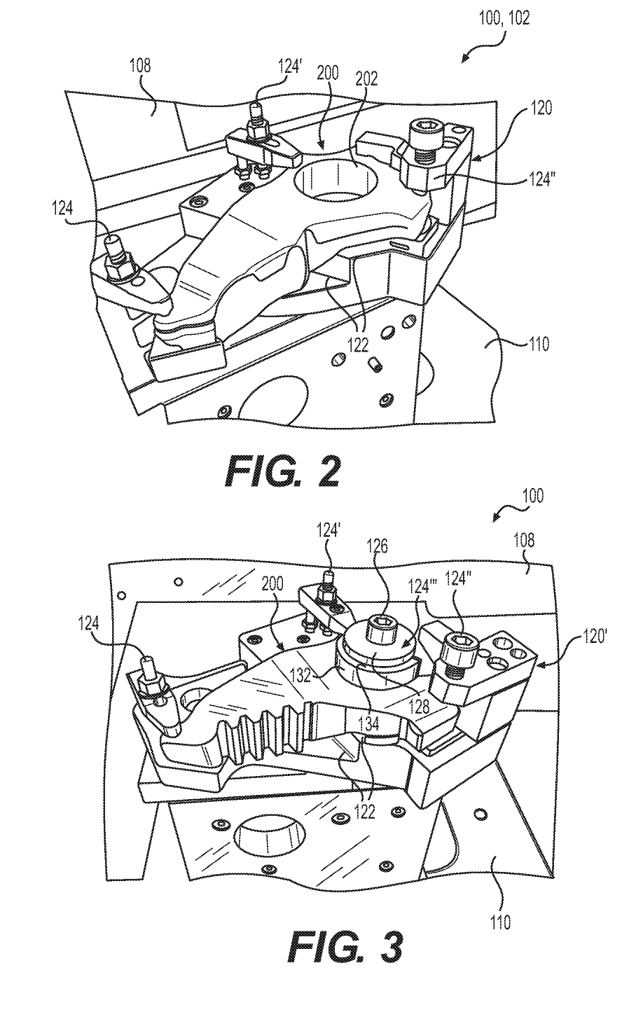

FIG. 1 depicts an embodiment of an apparatus 100 that may be used to machine a master track link. The apparatus includes a CNC machine having at least a four axis capability. In particular, a horizontal milling machine sold under the TRADENAME of MAKIINO a81 HMC may be used. However, it is contemplated that other milling machines may be used depending on the application. Also, the machining may be done manually, etc. The machine of FIG. 1 may include a frame 102, an enclosure 104 attached to the frame 102, a controller 106, and a door 112 that may open and close so that an operator or robot may enter and exit the interior 108 (shown in FIGS. 2 and 3) of the enclosure 104 for attaching or detaching parts from the table 110 of the machine, cleaning chips out of the machine, etc.

Looking at FIGS. 1-3, this machine is a four axis horizontal milling machine center including the frame 102, the table 110 attached to the frame 102 inside the enclosure 104, and a rotating spindle 114 attached to the frame 102 inside the enclosure 104. “Four axis” is a reference to the versatility of the possible movement of various portions of the machine. For example, the table 110 may be configured to rotate about an axis such as the Y-axis as shown in FIG. 1. The table 110 may also be able to translate along a Cartesian axis such as the Z-axis shown in FIG. 1. In addition to or in lieu of these various movements of the table 110, the spindle 114 may also be configured to move or translate along any Cartesian axis including the X axis, Y axis and the Z axis. As shown in FIG. 1, the spindle 114 is configured to hold a milling cutter 116 and rotate the cutter 116 about a first axis, such as the Z axis as shown in FIG. 1. Also, the spindle is configured to translate relative to the frame, such as along a direction parallel with the X-axis or parallel to the Y-axis (directions of translation of the spindle are denoted by 118 in FIG. 1). In some embodiments, an extra axis of movement (five axis machine) may be provided by allowing the spindle to pivot, so that the axis of rotation is no longer parallel to the Z-axis.

Referring now to FIGS. 2 and 3, a jig or fixture 120 may be attached to the table 110 in a manner known in the art. The fixture 120 may include a stepped platform 122 configured to support a master track link 200. As shown, the master track link 200 may be positioned on the platform 122 of the fixture 120 and a plurality of clamp arrangements 124 (e.g. toe clamps) may be provided that are configured to hold the master track link 200 to the fixture. FIG. 2 illustrates a bushing master track link 200, so called as its bore 202 is configured to receive a bushing of a track chain. FIG. 3 illustrates another fixture 120′ using a locating pin 132 configured to fit within the bore 202 of the master track link 200. As shown in FIG. 3, one of the clamp arrangements 124′″ engages the locating pin 132, helping to keep the master track link 200′ in place during machining. As shown, this clamp arrangement 124′″ includes a fastener 126 that is attached to the fixture 120′, pressing onto a washer 128 that impinges on the top surface 134 of the locating pin 132. Other configurations are possible.

The fixtures 120, 120′ were designed and manufactured to locate either on the X, Y, Z coordinates provided by a blueprint of the master track link (which are datums on the forging itself) or by using A, B, X datum points located on the master track link 200, 200′ itself in situ, (which are a combination of machined features like bores and locators on the forging) after the master track link 200, 200′ had been clamped to the fixture 120, 120′, respectively. More specifically, a bushing bore may be used as the primary datum, an Y1 locator may then be located and then three X points such as X1, X2 and X3. Testing revealed that using the latter technique helped reduce chatter and vibration slightly. Using the former technique is still possible if a robust fixture is used for performing the rough milling of the tooth profile. To that end, additional work supports may be provided at bottom of the master track link between it and the fixture to help reduce vibrations during machining, improving the accuracy of the milling process.

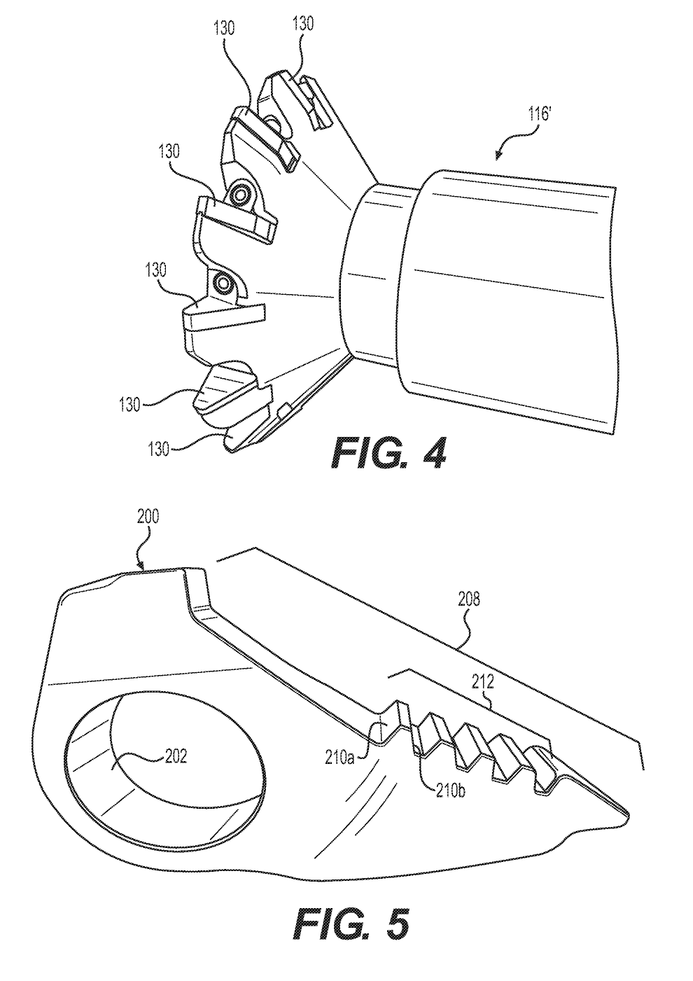

FIG. 4 shows a side milling cutter 116′ including a plurality of inserts 130, such as radially mounted inserts, configured to machine at least a portion of the tooth profile of the master track link. For this embodiment, the tooth profile is a rough tool profile but another side milling cutter configured to machine at least a portion of the finished tooth profile will be described later herein. This side milling cutter 116′ may be commercially purchased under the TRADENAME of SANDVIK and a part number of 162-140Q32-60 with a tool spindle having part number A1B05-5032100 and carbide inserts 130 having a part number of 176M60-N150612E-PM 1030. Although not shown in the figures, a face milling cutter may also be commercially purchased under the TRADENAME of COROMANT CAPTO with a part number of C5-391.05C-22 025M that is used to mill the top surfaces of the undulations of the tooth profile and, or angled surface of the tooth profile, etc. In practice, the face milling is typically done before the side milling but not in every case.

As used herein, “tooth profile” is to be interpreted broadly and include any geometry of master track link, including but not limited to undulations, that engage complimentarily shaped geometry of another master track link, helping to limit movement of the master track links once mated together along either direction of the track chain, which may exert tensile or compressive forces on the joined master track links.

Due to the versatility of the motion of the table and/or the spindle of the machine as described earlier herein with reference to FIG. 1, the face milling cutter may first create the general outline of the tooth profile when the face milling cutter is held by the spindle and the spindle is properly oriented relative to the fixture and the master track link. Then, the face milling cutter may be replaced via the tool changer of the machine with a side milling cutter and the orientation of the spindle and face side cutter may be changed relative to the fixture and master link by rotating and translating the table and/or spindle relative to each other. Then the undulations including their side surfaces and troughs may be machined. This process may be then be repeated when performing the finishing operation, etc. In some cases, only one fixture is necessary to hold the master link, eliminating the need to remove the master link from the fixture and attach it to another, saving time.

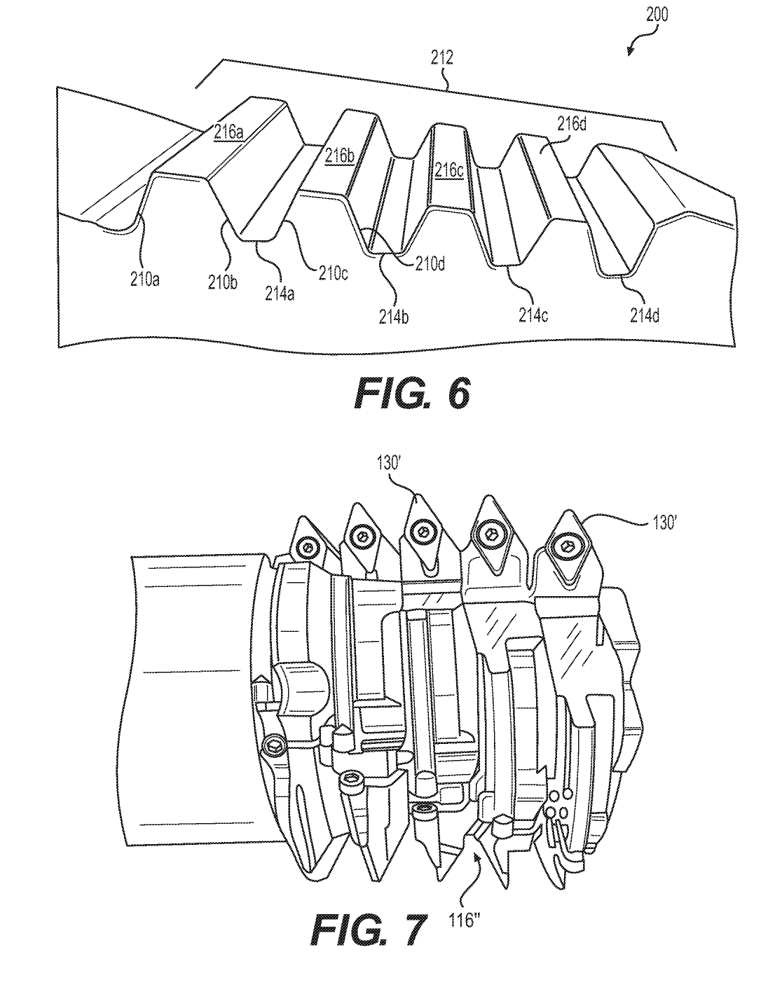

Turning now to FIGS. 5 and 6, the end configuration of the tooth profile 208 after the roughing operation has been completed on a master track link 200 using the side milling cutter 116 shown in FIG. 4 and a face milling cutter (not shown) can be seen. The shape of the inserts 130 of the side milling cutter 116 form the side surfaces 210 of the undulations 212 and bottom flat trough surface 214. The face milling cutter milled the top surfaces 216 of the undulations 212. Testing revealed that this embodiment was able to remove enough material from the master track link 200 in approximately two minutes such that only 1 mm material was left to be removed by the finishing operation. This cycle time was an improvement over the broaching process previously used to create the rough tooth profile.

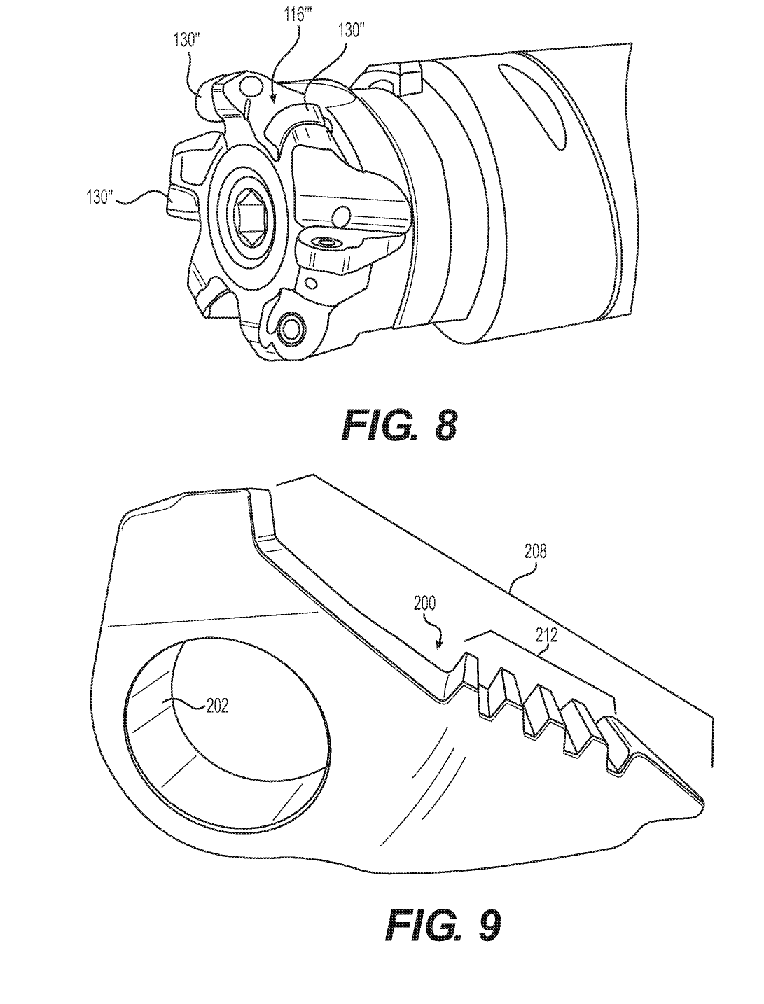

FIGS. 7 and 8 depict another side milling cutter and another face milling cutter that may be used to form the rough profile. As shown, this is a helical milling cutter with multiple flutes and radially mounted inserts. Tangentially mounted inserts may also be provided as an alternate option. The side milling cutter 116″ may be commercially purchased under the TRADENAME of KENNAMETAL having a part number of 6213121 and inserts 130′ having a part number of ER0512M05U00GUP and DCMT11T308MF. The face mailing cutter 116′ may also be purchased under the TRADENAME of KENNAMETAL having a part number of M4D063Z06522LN15 and inserts 130″ having a part number of LNGU15T6125RGE. The cycle time to create the rough tooth profile was approximately 2.5 minutes and the process left 1 mm or less of stock material for the finishing operation. It is to be understood that the machining time may vary for any of the embodiments discussed herein based on various parameters such as the size and type of the master track link, type of machine, type of inserts used, spindle and feed rates, and type of milling cutters, etc.

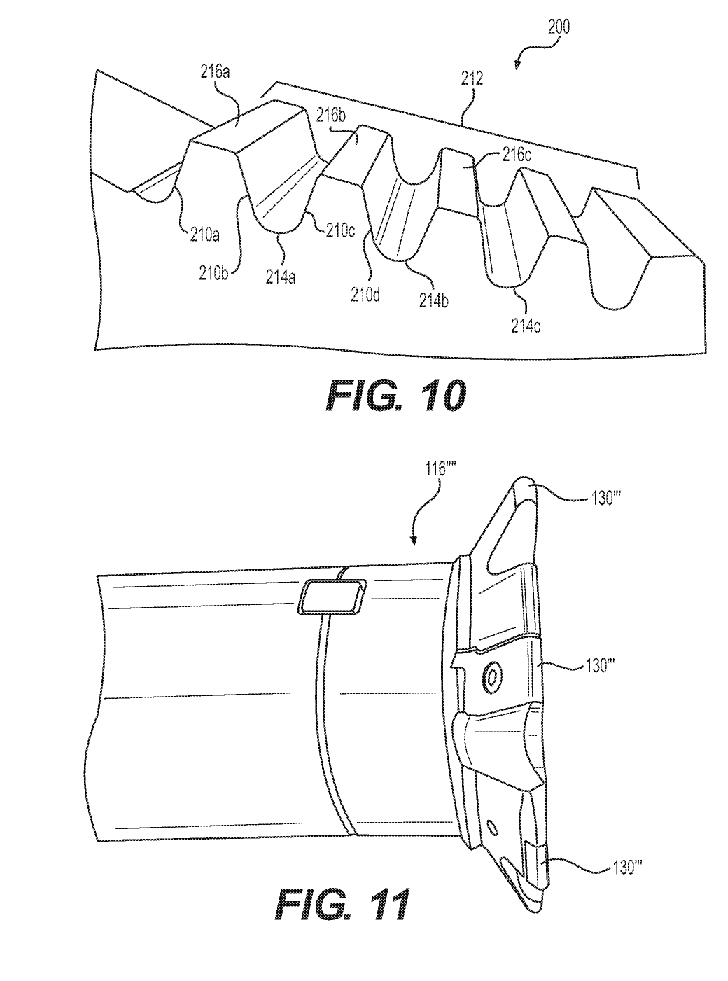

FIGS. 9 and 10 show a master track link 200 manufactured using the cutters 116″, 116′″ of FIGS. 7 and 8. As can be best seen in FIG. 10, the side surfaces 210 and trough surfaces 214 of the undulations are rounded, having been made by the profile of the inserts 130′ of the side milling cutter 116″ while the top surfaces 216 of the undulations 212 are made by the face mill 116′″.

FIG. 11 depicts a third embodiment of a side milling cutter 116″″ that may be commercially purchased under the TRADENAME of SECO having part number RM-360.10-03095314 using inserts 130′ having part number RI-5P19-28126. Though not shown, a face milling cutter may also be commercially purchased under the TRADENAME of SECO having a part number of RM-00535-281-106 using an insert having the part number NI-LN2512-28107. This style of cutter has tangentially mounted cutting inserts.

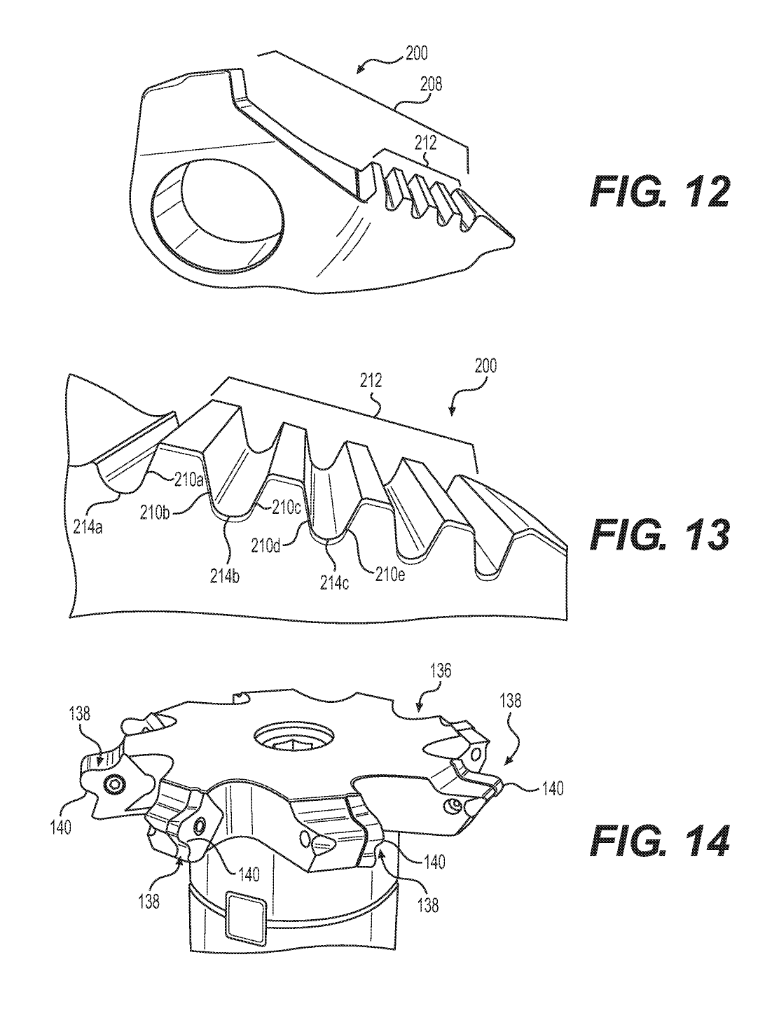

FIGS. 12 and 13 illustrate the resulting tooth profile 208 and undulations 212 formed using the cutters just described. The side surfaces 210 and trough surfaces 214 are slight offset and asymmetrical. The trough surfaces 214 are rounded, matching the perimeter of the inserts 130′″ of the side milling cutter 116″″. The cycle time was approximately 2.5 minutes and left about 1 mm or less of stock material for the finishing operation.

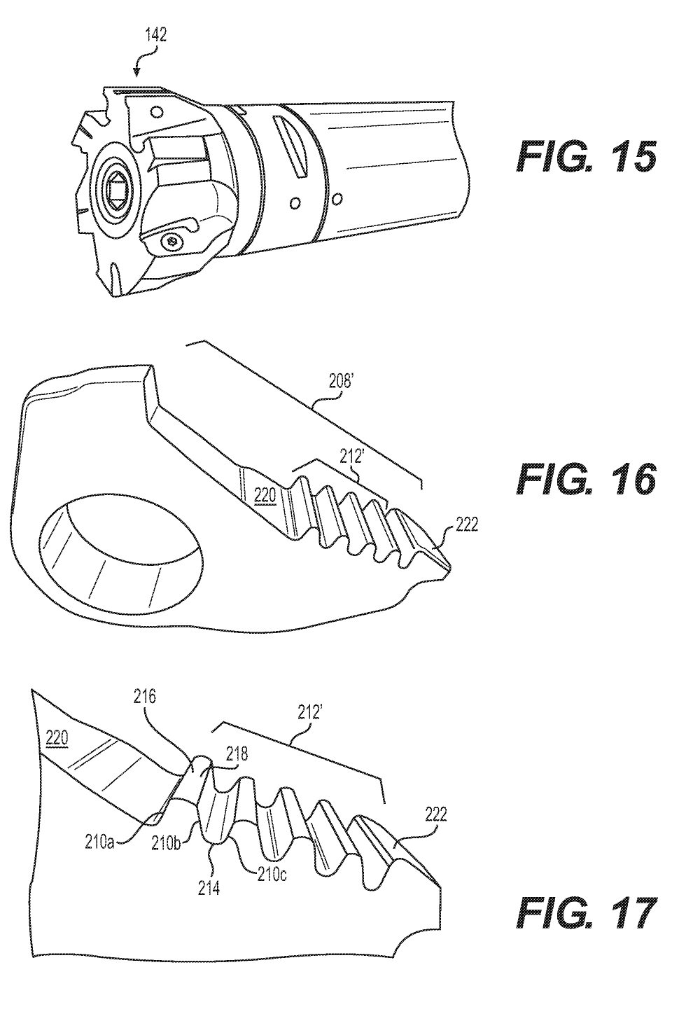

As alluded to earlier, the table and spindle would then be moved and oriented so that tooth profile finishing operations can be completed. In some cases, the finishing face milling step would occur first, necessitating a change of orientation and a switching of the tool. Then, the finishing side milling step would take place requiring another change of the tool and orientation. FIGS. 14 and 15 depict a custom made side milling cutter 136 and face milling cutter 138; respectively, specially made to machine the finished tooth profile 208′. The side milling cutter 136 includes a plurality of inserts 138 configured to machine at least a portion of the finished tooth profile 208′.

More particularly, looking at FIGS. 14, 16 and 17, the inserts 138 each define at least a partially undulating perimeter 140, which is designed to machine a trough 214, at least one side surface 210 and at least one blend 218 leading to the top surface 216 of an undulation. For this embodiment the undulating perimeter forms both side surfaces and both blends on either side of the trough simultaneously. Typically, each of the undulations are identically configured, allowing the same side milling cutter to create each undulation. This may not be true for other embodiments. Next, the face mill 142 would machine slight flats 216 on the top of the undulations 212 and then would machine the top angled surface 220 and bottom angled surface 222 adjacent on either side of the undulations 212′. In some cases, the face milling operation or portions thereof would be performed before the side milling operation. The cycle time was 3 minutes and 15 seconds and provided a surface finish of Ra 0.8 to 2.5 microns. Again, the machining time may vary for a host of reasons set forth earlier herein. Also, any of the machining parameters including the spindle and feed rates may be altered to achieve a desired surface finish.

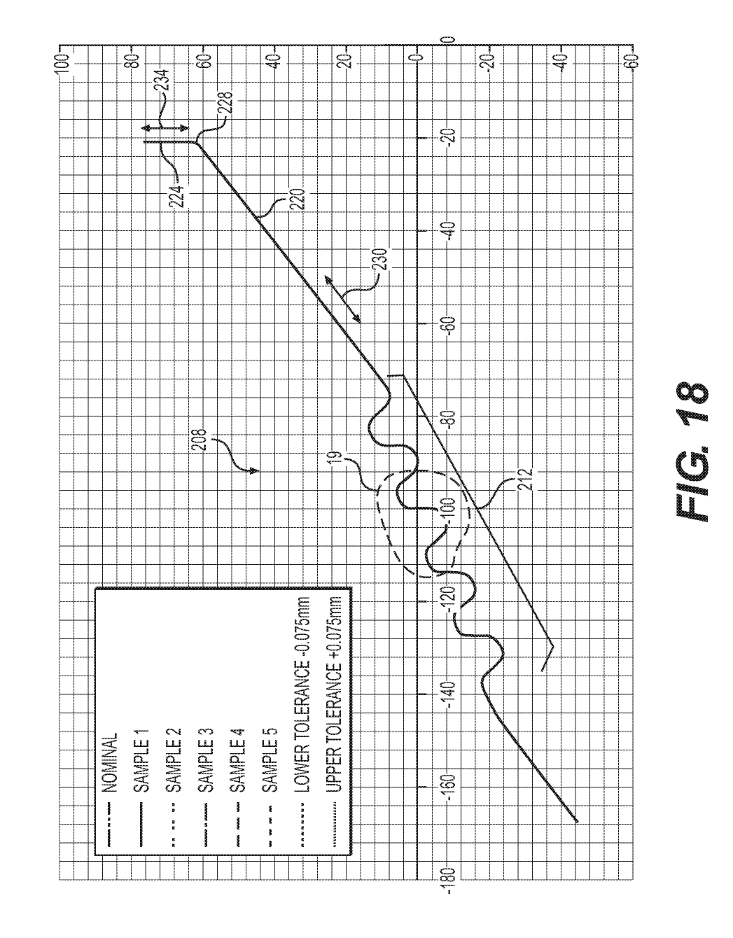

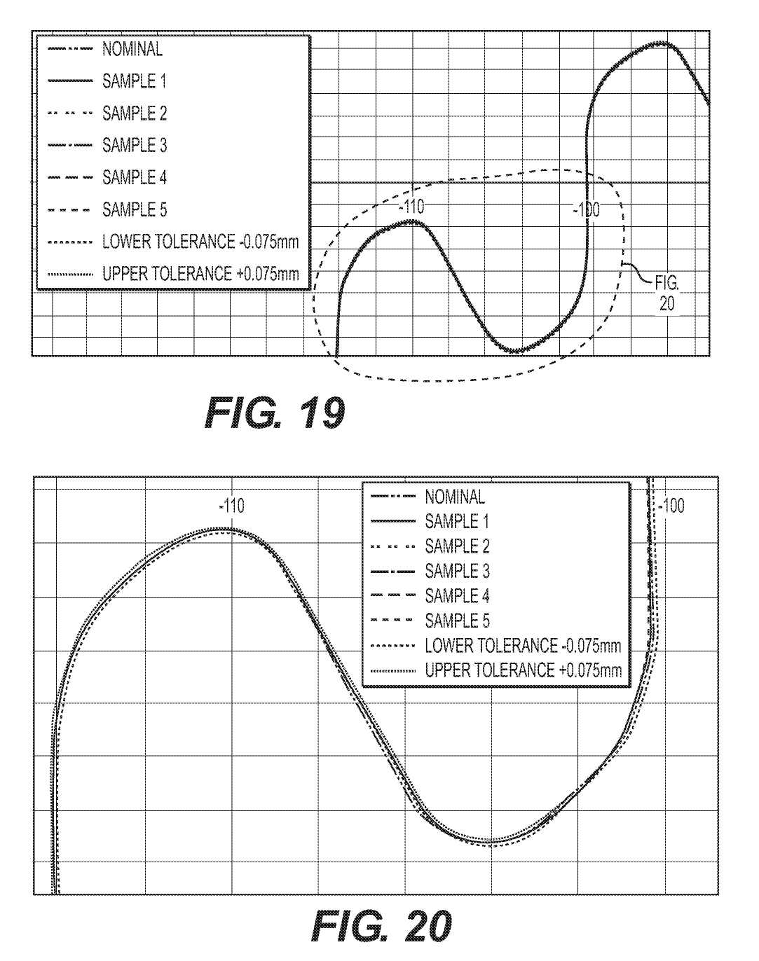

A CMM (Coordinate Measuring Machine) sold under the TRADENAME of ZEISS was used to measure and plot the finished tooth profile of a master pin track link 200 as shown in FIG. 28. FIG. 18 contains a graph plotting the finished tooth profile of FIGS. 16 and 17 versus the position along a horizontal and vertical axis, measured in millimeters. Though difficult to see in FIG. 18, the nominal or desired finished tooth profile is plotted as well as five measured finished tooth profiles. Also, the upper and lower boundaries of the tolerance range, equivalent to +/−0.075 mm is shown. At first glance, the measured finished tooth profiles match the nominal finished tooth profile satisfactorily.

FIG. 19 is an enlarged detail view of the graph of FIG. 18 and FIG. 20 is an enlarged detail view of FIG. 19. Enough detail is shown in FIG. 20 to see that all five samples were within tolerance, indicating that the finish tooth profile machined using the milling cutters was in fact satisfactory in the area of the undulations.

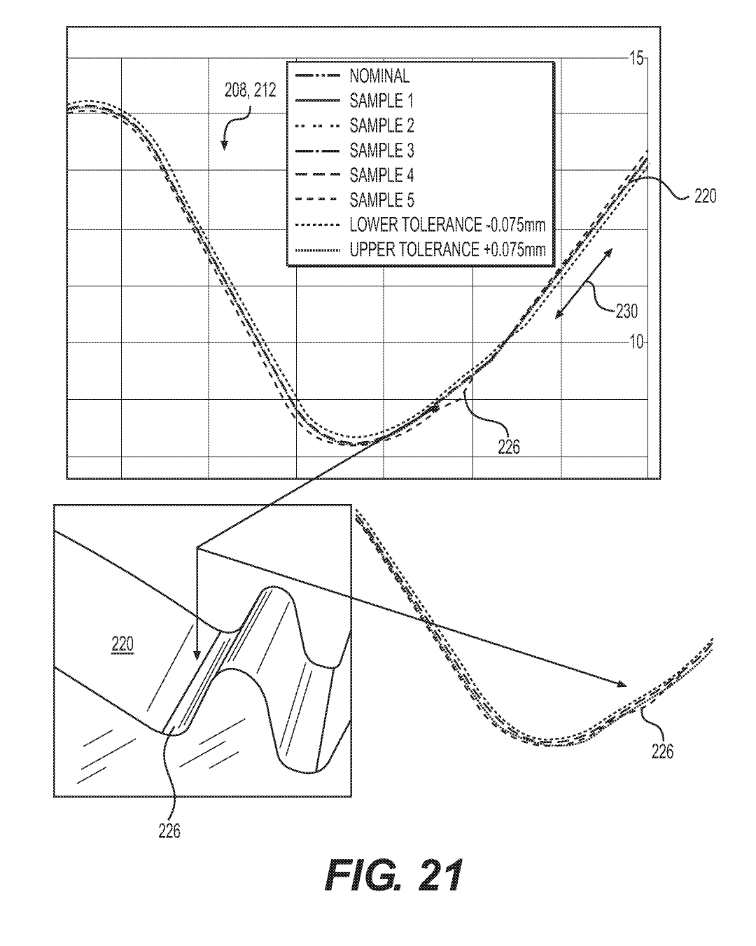

Looking at FIGS. 18 and 21 together, it can be seen that the tooth profile 208 includes a series of undulations 212, a vertically oriented surface 224 extending from the top or bottom surface and an angled surface 220 extending from the vertically oriented surface 224 to the undulations 212, forming an intersection 228 with the vertically oriented surface 224, wherein the angled surface 220 forms an undercut 226 along a direction 230 parallel with or tangent to the angled surface 220. The undercut 226 is formed by the face milling cutter or side milling cutter as the finished tooth profile is formed.

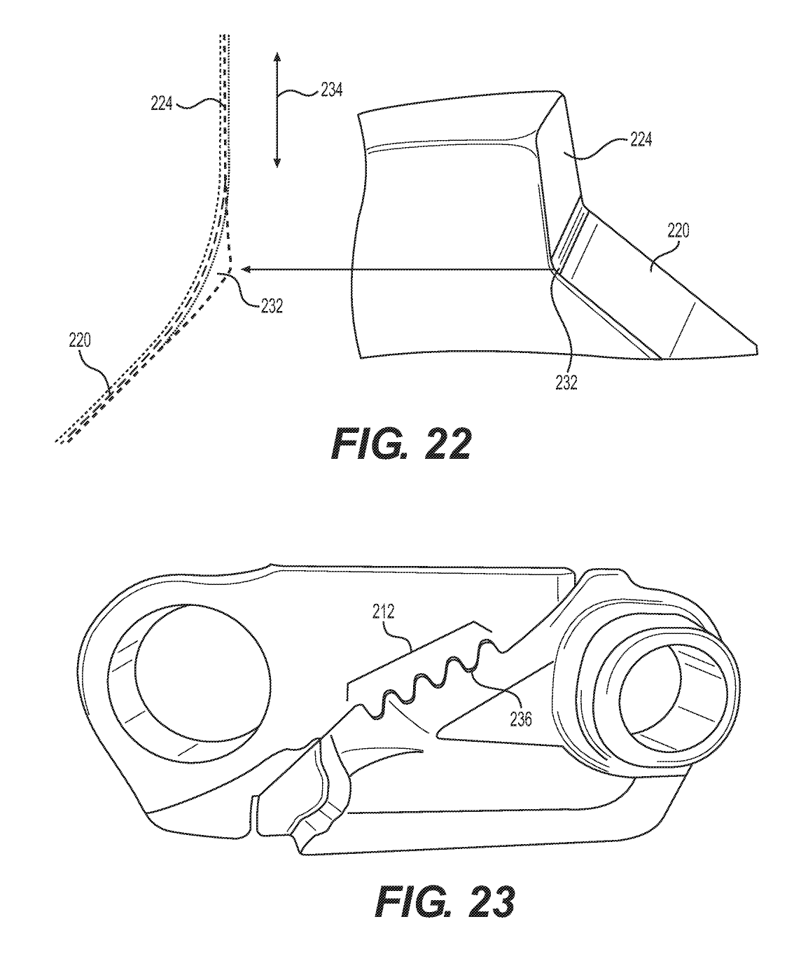

Referring now to FIGS. 18 and 22 together, it can also be seen that the tooth profile 208 includes a series of undulations 212, a vertically oriented 224 surface extending from the top or bottom surface and an angled surface 220 extending from the vertically oriented surface 224 to the undulations 212, forming an intersection 228 with the vertically oriented surface 224, wherein the vertically oriented surface 224 forms an undercut 232 along a direction parallel with or tangent 234 to the vertically oriented surface 224. Again, this undercut may be formed by the face milling cutter as the finished tooth profile is formed.

In some applications, these undercuts are acceptable. Therefore, more machining or tooling may not be required and these undercuts may be found on the master track links. In other cases, altering various machining parameters such as the insert or other tooling geometry may avoid the formation of the undercut.

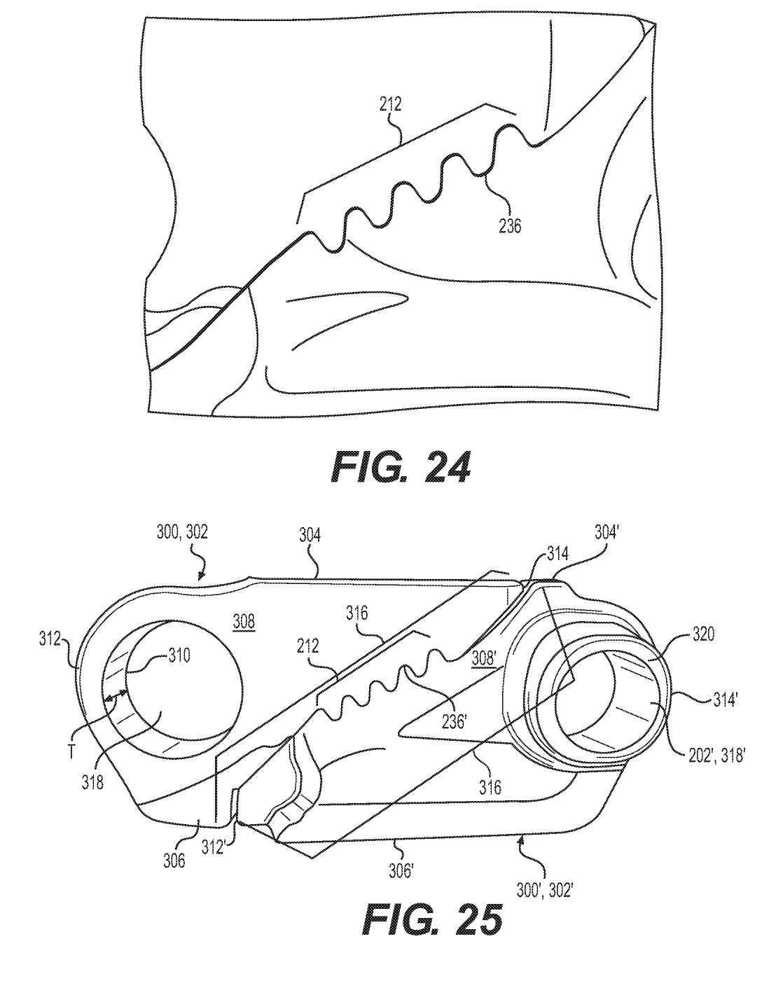

FIGS. 23 and 24 are front views of a bushing master track link mated with a pin master track link, wherein both master track links were manufactured using a previous process that involved broaching and then grinding the teeth. The small gap 236 found between some areas of the undulations 212 shows how closely such master track links are typically machined to obtain the desired performance.

On the other hand, FIGS. 24 and 25 illustrate a pin master track link and a bushing master track link where the bushing master track link was made using a process as described herein while the pin master track link was used by the previous process. As can be seen, the small gap 236′ shown in these figures is comparable to that shown in FIGS. 23 and 24, indicating that a suitable performance may be provided by the embodiments of the present disclosure. Also, this indicates that master track links now made using the process described herein may be used with other similarly configured master track links already in the field that were manufactured using the previous process.

While the master track links described herein have been primarily bushing master track links, it is contemplated that various embodiments of the present disclosure may be applied to a pin master track link, which can mate with a bushing master track link where both links are made using a similar process.

Therefore, FIG. 25 may be described in the following manner with respect to a mating pair of master track links made according to the present disclosure. A master track link 300 may comprise a body 302 defining a top surface 304, a bottom surface 306, a first side surface 308 and a second side surface 310 defining a thickness therebetween, a proximate end 312 and a distal end 314. In some cases, the body 302 defines a tooth profile 316 extending from the top surface 304 or the bottom surface 306 and the body 302 defines a bore 318 adjacent the distal end 314 or adjacent to the proximate end 312. The tooth profile 316 may exhibit finishing milling marks.

If the master track link is a master pin track link 300′, it may further comprise a boss 320 protruding from a side surface 308′ adjacent the distal end 314′, wherein the boss 320 defines the bore 318′. Also, the tooth profile 316′ extends from the top surface 304′. On the other hand, if the master track link is a bushing track link 300, the body 302 may define the bore 318 adjacent the proximate end 312 and the tooth profile 316 extends from the bottom surface 306. Other configurations of the matching master track links are possible.

### INDUSTRIAL APPLICABILITY

In practice, master track link, a mating pair of master track links, a chain using a master track link or mating pair of track link, according to an embodiment described herein may be sold, bought, manufactured or otherwise obtained in an OEM or after-market context.

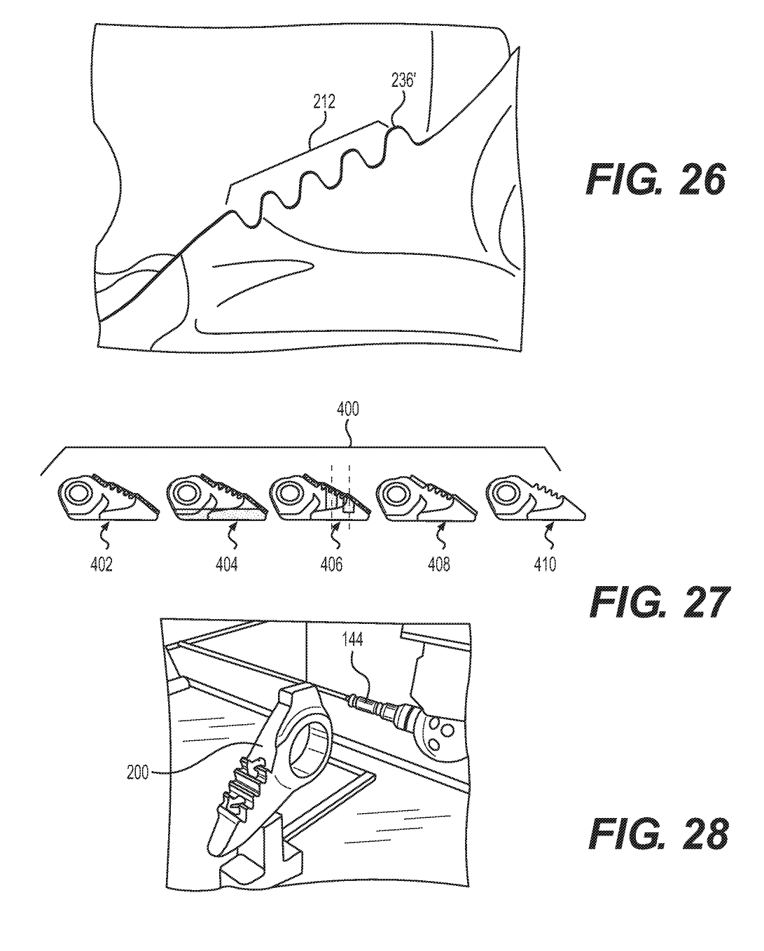

A method 400 of manufacturing a master track link according to an embodiment of the present disclosure will now be discussed referring to FIG. 27. This method 400 may comprise forging or casting the master track link as a blank part (step 402). Then, the method may comprise milling the rails and/or other dimensions of the master track link and heat treating the master track link (step 404). This may involve the use of conventional heat treating with a tempering step and/or induction heat treating the rails, etc. Then, the bore or bore(s) may be machined to a finish dimension and the fastener holes may be tapped (step 406). Next, the rough tooth profile may be machined (step 408). Finally, the final tooth profile may be formed using a finish grinding, finish milling, or a finish wire EDM process, etc. (step 410).

FIG. 28 is a flowchart regarding a method 500 for manufacturing a master track link, related to but more detailed than the method 400 of FIG. 27, comprising machining a rough tooth profile using a milling process (step 502) and machining a finished tooth profile using a milling process (step 504).

In some embodiments, machining the rough tooth profile includes using a commercially available side mill cutter and commercially available face mill cutter (step 506).

In other embodiments, machining the final tooth profile includes using a customized side mill cutter (step 508). In such a case, using a customized side mill cutter may include using a plurality of inserts having perimeters that are at least partially complimentarily shaped to match the desired finished tooth profile (step 510).

In yet further embodiments, machining the finished tooth profile includes machining the top surfaces of the undulations of the tooth profile using a face mill cutter (step 512).

In some cases, machining the tooth profile includes machining a depression on a surface of the profile, forming an undercut along a direction tangential to the surface (step 514).

Machining the finished tooth profile may include maintaining a tolerance of plus or minus 0.075 mm (step 516). Other tolerances are possible. In some applications, the tolerance may be +/−0.04 mm or +/−0.125 mm. Other tolerance ranges may be suitable such as those that range from +/−0.04 mm to +/−0.125 mm.

In general, the method may further comprise measuring the dimensions of the finished tooth profile using a CMM (step 518) and then adjusting the milling process based on data concerning the dimensions measured via the CMM (step 520).

The rough blank of the master track link may be provided by forging or casting a rough blank of the master link prior to machining a tooth profile (step 522), milling the rail geometry on the master link, finishing the bore and drilling and tapping fastener apertures on the master link (step 524). Typically, milling the rail geometry, finishing the bore and drilling and tapping the fastener apertures occurs before the finished tooth profile is machined (step 526) or sometimes, even before the rough tooth profile has been machined (step 528).

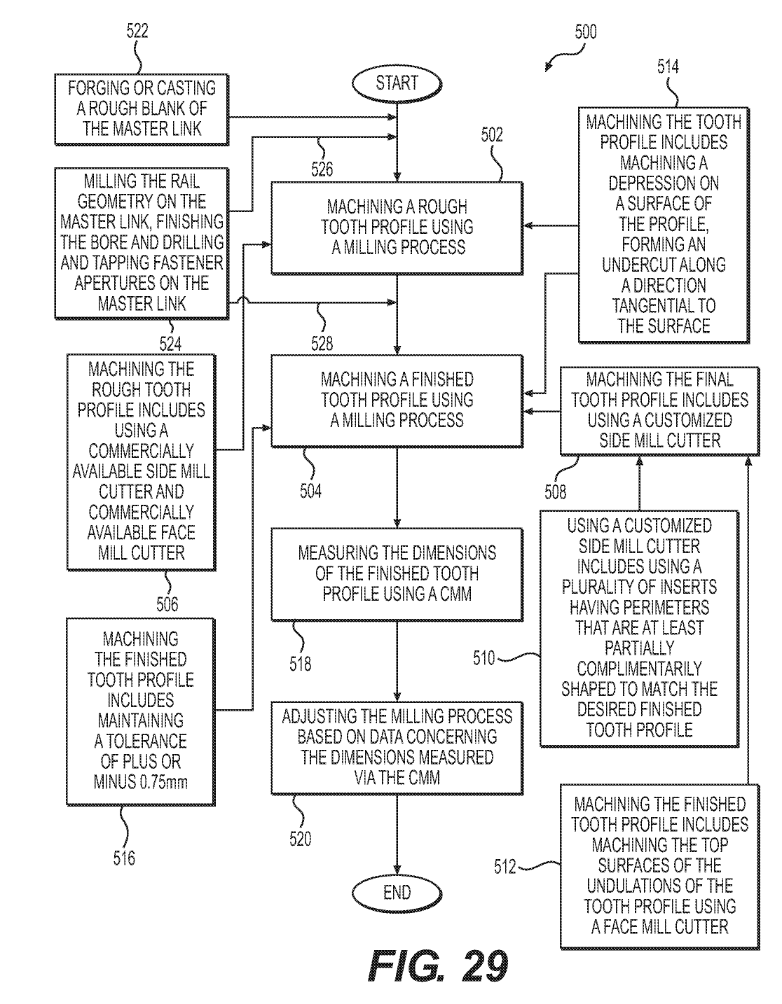

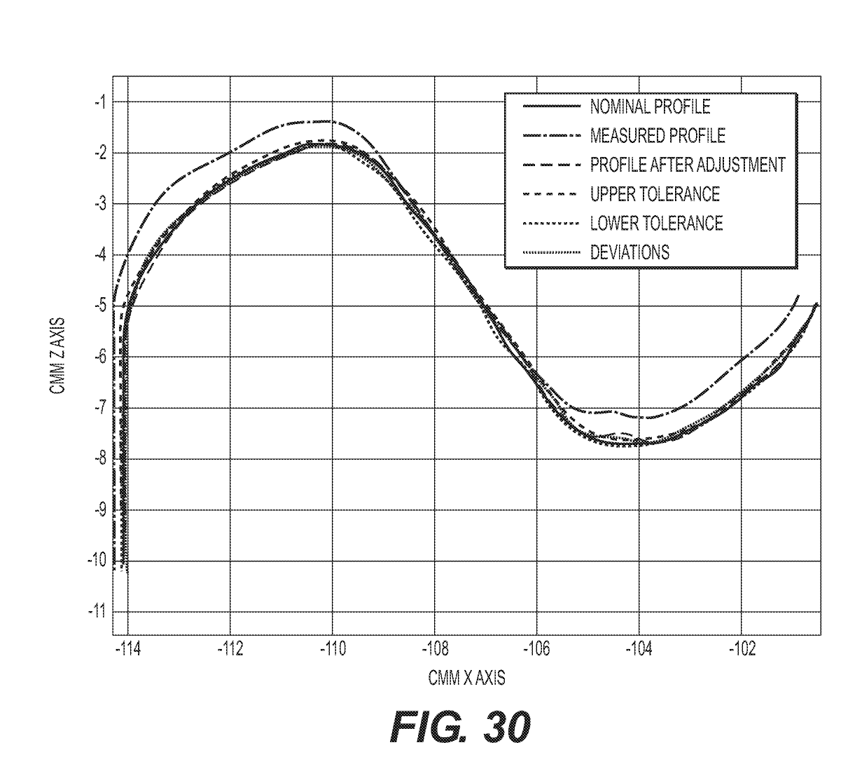

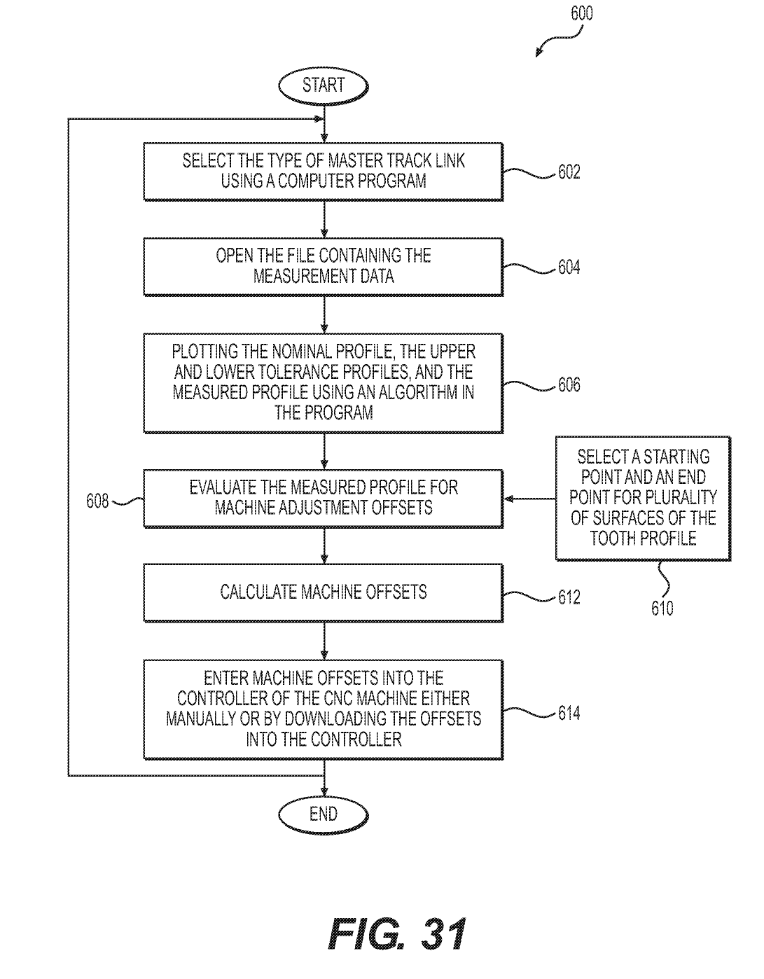

Now, a method 600 related to step 520 of FIG. 29 will be discussed in more detail in reference to FIGS. 30 and 31. First, the type of master track link (pin or bushing link) may be selected using a software program such as an EXCEL program, customized application, or the like (step 602). Then, the file containing the measurement data will be opened (step 604). Next, an algorithm in the software program plots the nominal profile, the upper and lower tolerance profiles, and the measured profile from the CMM machine (step 606). An example of this is shown in FIG. 30. While only a portion of a tooth profile is shown there, it is to be understood that the entire profile could be analyzed this way.

Now, the measured profile would be evaluated for machine offset adjustments (step 608). This could be accomplished in a variety of ways. One way of doing this would be to select two points, such as a starting point and an end point, for a plurality of surfaces of the tooth profile (step 610). Such surfaces include the vertical surface 224, angled surfaces 220, 222, side surfaces 210 of the undulations 212, top surfaces 216 of the undulations 212, etc. (see FIGS. 17 and 18). Next, the program would use its analysis tool to run an algorithm to calculate coordinates of the desired profile and associated machine offsets, creating a best fit curve that is within the upper and lower tolerance boundaries (step 612). An operator may then manually enter the offsets into the controller of the CNC equipment. Alternatively, the offsets may be downloaded into the controller, etc. (step 614). This process repeats itself until the desired master track link profile is measured. Also, this process may begin anytime the master track link profile is out of tolerance.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A master track link comprising:
a body defining a top surface, a bottom surface, a first side surface and a second side surface defining a thickness therebetween, a proximate end and a distal end; wherein
the body further defines a tooth profile including a plurality of surfaces, the tooth profile extending from the top or bottom surface;
the body defines a bore adjacent the distal end or adjacent to the proximate end; and
all the surfaces of the tooth profile exhibit finishing milling marks.

2. The master track link of claim 1 further comprising a boss protruding from a side surface adjacent the distal end, wherein the boss defines the bore.

3. The master track link of claim 1 wherein the tooth profile includes a series of undulations, a vertically oriented surface extending from the top or bottom surface and an angled surface extending from the vertically oriented surface to the undulations, forming an intersection with the vertically oriented surface, wherein the angled surface forms an undercut along a direction parallel with the angled surface.

4. The master track link of claim 1 wherein the tooth profile includes a series of undulations, a vertically oriented surface extending from the top or bottom surface and an angled surface extending from the vertically oriented surface to the undulations, forming an intersection with the vertically oriented surface, wherein the vertically oriented surface forms an undercut along a direction parallel with the vertically oriented surface.

5. An apparatus for machining a master track link comprising:
a CNC machine including at least four axis maneuverability, a frame, a table attached to the frame, and a rotating spindle attached to the frame;
a fixture attached to the table including a stepped platform configured to support a master track link;
a master track link positioned on the platform of the fixture; and
a plurality of clamp arrangements configured to hold the master track link to the fixture.

6. The apparatus of claim 5 wherein the table is configured to rotate about a first axis.

7. The apparatus of claim 6 wherein the spindle is configured to hold a milling cutter and rotate the cutter about a second axis, and rotation of the table moves the master track link relative to the milling cutter, changing the orientation of the milling cutter relative to the master track link.

8. The apparatus of claim 5 further comprising a side milling cutter including a plurality of inserts configured to machine at least a portion of the finished tooth profile, the inserts each defining at least a partially undulating perimeter.

9. The apparatus of claim 5 wherein the fixture includes a locating pin, the master track link includes a bore, the locating pin is disposed in the bore, and one of the plurality of clamping arrangements engages the locating pin.

10. A method for manufacturing a master track link comprising:
machining a rough tooth profile using a milling process; and
machining a finished tooth profile using a milling process.

11. The method of claim 10 wherein machining the rough tooth profile includes using a commercially available side mill cutter and commercially available face mill cutter.

12. The method of claim 10 wherein machining the final tooth profile includes using a customized side mill cutter.

13. The method of claim 12 wherein using a customized side mill cutter includes using a plurality of inserts having perimeters that are at least partially complimentarily shaped to match the desired finished tooth profile.

14. The method of claim 12 wherein machining the finished tooth profile includes machining the top surfaces of the undulations of the tooth profile using a face mill cutter.

15. The method of claim 10 wherein machining the tooth profile includes machining a depression on a surface of the profile, forming an undercut along a direction tangential to the surface.

16. The method of claim 10 wherein machining the finished tooth profile includes maintaining a tolerance of plus or minus 0.075 mm.

17. The method of claim 10 further comprising measuring the dimensions of the finished tooth profile using a CMM.

18. The method of claim 17 further comprising adjusting the milling process based on data concerning the dimensions measured via the CMM.

19. The method of claim 10 further comprising forging or casting a rough blank of the master link prior to machining a tooth profile, milling the rail geometry on the master link, finishing the bore and drilling and tapping fastener apertures on the master link.

20. The method of claim 19 wherein milling the rail geometry, finishing the bore and drilling and tapping the fastener apertures occurs before the finished tooth profile is machined.
